(19) United States
(12) Patent Application Publication
(10) Pub. No.: US 2019/0062665 A1
(43) Pub. Date: Feb. 28, 2019

(54) REFRIGERATOR OIL AND REFRIGERATOR OIL COMPOSITION

(71) Applicant: IDEMITSU KOSAN CO., LTD., Chiyoda-ku, Tokyo (JP)

(72) Inventor: Tomoya MATSUMOTO, Funabashi-shi (JP)

(73) Assignee: IDEMITSU KOSAN CO., LTD., Chiyoda-ku, Tokyo (JP)

(21) Appl. No.: 16/076,977

(22) PCT Filed: Feb. 21, 2017
(86) PCT No.: PCT/JP2017/006347

§ 371 Date: Aug. 9, 2018

(30) Foreign Application Priority Data
Feb. 29, 2016 (JP) 2016-038222

(51) Int. Cl. C10M 169/04; C10M 107/24; C10M 107/34; C10M 105/38; C10M 137/04; C10M 129/08; C10M 141/10; C09K 5/04; F25B 1/00

(52) U.S. Cl. CPC C10M 169/04; C09K 2205/122; C10M 107/34; C10M 105/38; C10M 137/04; C10M 129/08; C10M 141/10; C09K 5/045; F25B 1/00; C10M 2209/043; C10M 2209/1055; C10M 2207/2835; C10M 2223/041; C10M 2207/022; C10N 2240/30; C09K 2205/24; C10M 107/24

(57) ABSTRACT

In accordance with a refrigerator oil including a polyphosphate ester-based compound, a polyhydric alcohol, and a base oil containing an oxygen-containing organic compound, it is possible to provide a refrigerator oil capable of reducing a coefficient of friction, a refrigerator oil composition, and a method for producing a refrigerator oil.

### TECHNICAL FIELD

The present invention relates to a refrigerator oil and a refrigerator oil composition using the refrigerator oil.

### BACKGROUND ART

Refrigerators have a structure in which a mixture of a refrigerant and a refrigerator oil (hereinafter, the mixture is also referred to as “refrigerator oil composition”) is circulated within a closed system, and the refrigerator oil is required to have compatibility with the refrigerant, stability, and lubricating performance. In order to easily satisfy these requirements, refrigerator oils containing, as a major component, an oxygen-containing organic compound, such as a vinyl ether compound, etc., are frequently used (see, for example, PTL 1).

Meanwhile, a hydrofluorocarbon (HFC) that is low in terms of an environmental load is being used as the refrigerant in place of a hydrochlorofluorocarbon (HCFC) which has been frequently used so far. Among HFCs, a saturated hydrofluorocarbon (saturated HFC), such as R32 (difluoroethane), R410A (a mixture of difluoroethane and pentafluoroethane), etc., is frequently used.

As technologies for improving a lubricating performance, such as compatibility with such a saturated HFC refrigerant, wear resistance, seizure resistance, etc., it is known to add a phosphate ester compound having one phosphorus atom, such as tricresyl phosphate (TCP), etc., to a base oil composed of an oxygen-containing organic compound (see, for example, PTL 2).

Furthermore, use of, as the hydrofluorocarbon, an unsaturated hydrofluorocarbon (HFO) with a low global warming potential, such as HFO1234ze (1,3,3,3-tetrafluoropropene), HFO1234yf (2,3,3,3-tetrafluoropropene), etc., is recently investigated, too.

In view of the matter that the unsaturated hydrofluorocarbon has an unsaturated bond in a molecule thereof, it is low in the heat/chemical stability as compared with the saturated HFC. Therefore, blending with an additive different from the saturated HFC is also investigated. For example, as disclosed in PTLs 3 to 6, in order to prevent the matter that the refrigerant is polymerized to become waxy from occurring, it is investigated to blend the refrigerator oil with a polyhydric alcohol, such as ethylene glycol, etc., as a polymerization paraffin inhibitor.

### CITATION LIST

### Patent Literature

PTL 1: JP 6-128578 A

PTL 2: JP 10-130683 A

PTL 3: JP 2011-021870 A

PTL 4: JP 2011-021871 A

PTL 5: JP 2011-057885 A

PTL 6: JP 2011-058747 A

### SUMMARY OF INVENTION

### Technical Problem

Now, a requirement for energy conservation is increasing in the refrigerator field from year to year, and it is demanded to improve a coefficient of performance (COP). Accordingly, in a refrigerator oil, in order to improve the COP in addition to the wear resistance, it is demanded to reduce a coefficient of friction in a sliding portion of the refrigerator.

However, as disclosed in PTL 2, even if the phosphate ester compound having one phosphorus atom, such as TCP, etc., is blended in the refrigerator oil, it is difficult to sufficiently reduce the coefficient of friction while making the wear resistance good.

In addition, in PTLs 3 to 6, it is merely disclosed that the formation of a waxy solid is prevented from occurring, but it is not mentioned to make the wear resistance good or to reduce the coefficient of friction.

In view of the foregoing problems, the present invention has been made, and a problem thereof is to provide a refrigerator oil capable of reducing a coefficient of friction while making the wear resistance good, a refrigerator oil composition, and a method for producing a refrigerator oil.

### Solution to Problem

The present inventor and others made extensive and intensive investigations, and as a result, it has been found that by incorporating both a specified phosphorus-based compound having at least two phosphorus atoms in one molecule thereof and a polyhydric alcohol into a base oil containing an oxygen-containing organic compound, the aforementioned problem can be solved, thereby leading to accomplishment of the present invention. The present invention provides a refrigerator oil, a refrigerator oil composition, and a method for producing a refrigerator oil, as mentioned below.

(1) A refrigerator oil including a polyphosphate ester-based compound, a polyhydric alcohol, and a base oil containing an oxygen-containing organic compound.
(2) A refrigerator oil composition including a refrigerant and the refrigerator oil as set forth in the above (1).
(3) A method for producing a refrigerator oil, including blending a base oil containing an oxygen-containing organic compound with at least a polyphosphate ester-based compound and a polyhydric alcohol, to obtain a refrigerator oil.

### Advantageous Effects of Invention

In accordance with the present invention, it is possible to provide a refrigerator oil capable of reducing a coefficient of friction while making the wear resistance good, a refrigerator oil composition, and a method for producing a refrigerator oil.

### DESCRIPTION OF EMBODIMENTS

The present invention is hereunder described by reference to embodiments.

The refrigerator oil according one embodiment of the present invention includes a base oil, a polyphosphate ester-based compound, and a polyhydric alcohol. Each of components that are contained in the refrigerator oil is hereunder described in detail.

### [Base Oil]

The base oil in the present embodiment is one containing an oxygen-containing organic compound. Examples of the oxygen-containing organic compound include a synthetic oil containing an ether group, a ketone group, an ester group, a carbonate group, or the like in a molecule thereof; and a synthetic oil containing, together with such a group, a hetero atom (e.g., a sulfur atom, a fluorine atom, a chlorine atom, a silicon atom, a nitrogen atom, etc.). More specifically, examples thereof include a polyvinyl ether compound (PVE), a polyoxyalkylene glycol compound (PAG), a copolymer of a poly(oxy)alkylene glycol or a monoether thereof and a polyvinyl ether (ECP), and a polyol ester compound (POE). The oxygen-containing organic compound may be used solely, or may be used in combination of two or more thereof.

Of those, one or more selected from a polyvinyl ether compound (PVE) and a polyoxyalkylene glycol compound (PAG) are preferred, and above all, one or more selected from a polyvinyl ether compound (PVE) are more preferred. In particular, in the case where PVE is used together with a polyphosphate ester compound which is represented by a general formula (1) as mentioned later, and in which R⁹ is a group represented by a general formula (2), or a polyphosphate ester compound which is represented by a general formula (5), the coefficient of friction and the wear resistance are easily made good.

The oxygen-containing organic compound is one serving as a major component of the refrigerator oil. The content of the oxygen-containing organic compound is preferably 70 to 99.98 mass %, more preferably 90 to 99.5 mass %, and still more preferably 93.0 to 99.3 mass % relative to the whole amount of the refrigerator oil.

PVE, PAG, ECP, and POE, each of which is used as the base oil, are hereunder described in more detail.

### <Polyvinyl Ether Compound (PVE)>

The polyvinyl ether compound (PVE) is a polymer having a vinyl ether-derived constituent unit, and specifically, examples thereof include a polyvinyl ether compound having a constituent unit represented by the following general formula (A-1).

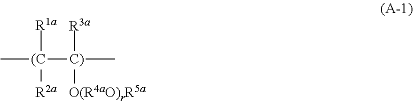

In the general formula (A-1), R^{1a}, R^{2a}, and R^{3a} each independently represent a hydrogen atom or a hydrocarbon group having 1 to 8 carbon atoms, and they may be the same as or different from each other. Here, specifically, examples of the hydrocarbon group include an alkyl group, such as a methyl group, an ethyl group, a n-propyl group, an isopropyl group, a n-butyl group, an isobutyl group, a sec-butyl group, a tert-butyl group, a pentyl group of every kind, a hexyl group of every kind, a heptyl group of every kind, an octyl group of every kind, etc.; a cycloalkyl group, such as a cyclopentyl group, a cyclohexyl group, a methylcyclohexyl group of every kind, an ethylcyclohexyl group of every kind, a dimethylcyclohexyl group of every kind, etc.; an aryl group, such as a phenyl group, a methylphenyl group of every kind, an ethylphenyl group of every kind, a dimethylphenyl group of every kind, etc.; and an arylalkyl group, such as a benzyl group, a phenylethyl group of every kind, a methylbenzyl group of every kind, etc.

Of those, R^{1a}, R^{2a}, and R^{3a} are each preferably an alkyl group, more preferably a hydrogen atom or an alkyl group having 3 or less carbon atoms, and still more preferably a hydrogen atom.

In the general formula (A-1), r represents a repeating number, and an average value thereof is a number ranging from 0 to 10, and r preferably represents 0.

R^{4a} represents a divalent hydrocarbon group having 2 to 10 carbon atoms. Here, specifically, examples of the divalent hydrocarbon group having 2 to 10 carbon atoms include a divalent aliphatic hydrocarbon group, such as an ethylene group, a phenylethylene group, a 1,2-propylene group, a 2-phenyl-1,2-propylene group, a 1,3-propylene group, a butylene group of every kind, a pentylene group of every kind, a hexylene group of every kind, a heptylene group of every kind, an octylene group of every kind, a nonylene group of every kind, a decylene group of every kind, etc.; an alicyclic hydrocarbon group having two bonding sites in an alicyclic hydrocarbon, such as cyclohexane, methylcyclohexane, ethylcyclohexane, dimethylcyclohexane, propylcyclohexane, etc.; a divalent aromatic hydrocarbon group, such as a phenylene group of every kind, a methylphenylene group of every kind, an ethylphenylene group of every kind, a dimethylphenylene group of every kind, a naphthylene group of every kind, etc.; an alkyl aromatic hydrocarbon group having a monovalent bonding site in each of an alkyl group moiety and an aromatic moiety of an alkyl aromatic hydrocarbon, such as toluene, ethylbenzene, etc.; an alkyl aromatic hydrocarbon group having bonding sites in an alkyl group moiety of a polyalkyl aromatic hydrocarbon, such as xylene, diethylbenzene, etc.; and the like. Of those, a divalent aliphatic hydrocarbon group is preferred, and a divalent aliphatic hydrocarbon group having 2 to 4 carbon atoms is more preferred. In addition, in the case where plural R⁴aO's are present, the plural R⁴aO's may be the same as or different from each other.

Furthermore, in the general formula (A-1), R^{5a} represents a hydrocarbon group having 1 to 10 carbon atoms. Specifically, examples of this hydrocarbon group include an alkyl group, such as a methyl group, an ethyl group, a n-propyl group, an isopropyl group, a n-butyl group, an isobutyl group, a sec-butyl group, a tert-butyl group, a pentyl group of every kind, a hexyl group of every kind, a heptyl group of every kind, an octyl group of every kind, a nonyl group of every kind, a decyl group of every kind, etc.; a cycloalkyl group, such as a cyclopentyl group, a cyclohexyl group, a methylcyclohexyl group of every kind, an ethylcyclohexyl group of every kind, a propylcyclohexyl group of every kind, a dimethylcyclohexyl group of every kind, etc.; an aryl group, such as a phenyl group, a methylphenyl group of every kind, an ethylphenyl group of every kind, a dimethylphenyl group of every kind, a propylphenyl group of every kind, a trimethylphenyl group of every kind, a butylphenyl group of every kind, a naphthyl group of every kind, etc.; and an arylalkyl group, such as a benzyl group, a phenylethyl group of every kind, a methylbenzyl group of every kind, a phenylpropyl group of every kind, a phenylbutyl group of every kind, etc. Of those, a hydrocarbon group having 1 to 8 carbon atoms is preferred, and an alkyl group having 1 to 6 carbon atoms is more preferred. The alkyl groups may be any of straight-chain, branched, and cyclic groups.

Of the polyvinyl ether compounds having the constituent unit represented by the general formula (A-1), a polymer or copolymer containing 50 to 100 mol % of a constituent unit in which all of R^{1a}, R^{2a}, and R^{3a} are a hydrogen atom, r is 0, and R^{5a} is an ethyl group; and 0 to 50 mol % of a constituent unit in which all of R^{1a}, R^{2a}, and R^{3a} are a hydrogen atom, r is 0, and R^{5a} is an alkyl group having 3 or 4 carbon atoms is preferred. It is more preferred that the proportion of the constituent unit in which R^{5a} is an ethyl group is 70 to 100 mol %, and the proportion of the constituent unit in which R^{5a} is an alkyl group having 3 or 4 carbon atoms is 0 to 30 mol %; and it is still more preferred that the former is 80 to 95 mol %, and the latter is 5 to 20 mol %.

Examples of the alkyl group having 3 or 4 carbon atoms in R^{5a} include a n-propyl group, an isopropyl group, a n-butyl group, an isobutyl group, a sec-butyl group, and a tert-butyl group, with an isobutyl group being especially preferred.

Although the polyvinyl ether compound is one having the constituent unit represented by the general formula (A-1), a repeating number thereof may be properly chosen according to a desired kinematic viscosity.

The aforementioned polyvinyl ether compound can be produced through polymerization of a corresponding vinyl ether-based monomer. The vinyl ether-based monomer that can be used herein is one represented by the following general formula (A-2).

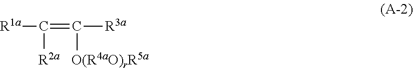

In the formula, R^{1a}, R^{2a}, R^{3a}, R^{4a}, R^{5a}, and r are the same as those mentioned above.

As this vinyl ether-based monomer, there are various monomers corresponding to the aforementioned polyvinyl ether compounds. Examples thereof include vinyl methyl ether, vinyl ethyl ether, vinyl n-propyl ether, vinyl isopropyl ether, vinyl n-butyl ether, vinyl isobutyl ether, vinyl sec-butyl ether, vinyl tert-butyl ether, vinyl n-pentyl ether, vinyl n-hexyl ether, vinyl 2-methoxyethyl ether, vinyl 2-ethoxyethyl ether, vinyl 2-methoxy-1-methylethyl ether, vinyl 2-methoxypropyl ether, vinyl 3,6-dioxaheptyl ether, vinyl 3,6,9-trioxadecyl ether, vinyl 1,4-dimethyl-3,6-dioxaheptyl ether, vinyl 1,4,7-trimethyl-3,6,9-trioxadecyl ether, vinyl 2,6-dioxa-4-heptyl ether, vinyl 2,6,9-trioxa-4-decyl ether, 1-methoxypropene, 1-ethoxypropene, 1-n-propoxypropene, 1-isopropoxypropene, 1-n-butoxypropene, 1-isobutoxypropene, 1-sec-butoxypropene, 1-tert-butoxypropene, 2-methoxypropene, 2-ethoxypropene, 2-n-propoxypropene, 2-isopropoxypropene, 2-n-butoxypropene, 2-isobutoxypropene, 2-sec-butoxypropene, 2-tert-butoxypropene, 1-methoxy-1-butene, 1-ethoxy-1-butene, 1-n-propoxy-1-butene, 1-isopropoxy-1-butene, 1-n-butoxy-1-butene, 1-isobutoxy-1-butene, 1-sec-butoxy-1-butene, 1-tert-butoxy-1-butene, 2-methoxy-1-butene, 2-ethoxy-1-butene, 2-n-propoxy-1-butene, 2-isopropoxy-1-butene, 2-n-butoxy-1-butene, 2-isobutoxy-1-butene, 2-sec-butoxy-1-butene, 2-tert-butoxy-1-butene, 2-methoxy-2-butene, 2-ethoxy-2-butene, 2-n-propoxy-2-butene, 2-isopropoxy-2-butene, 2-n-butoxy-2-butene, 2-isobutoxy-2-butene, 2-sec-butoxy-2-butene, 2-tert-butoxy-2-butene, and the like. These vinyl ether-based monomers can be produced by a known method.

In an end moiety of the polymer having the constituent unit represented by the general formula (A-1), a monovalent group derived from a saturated hydrocarbon, an ether, an alcohol, a ketone, an amide, a nitrile, or the like may be introduced by a known method.

Above all, as the polyvinyl ether compound, those having an end structure of any of the following (1) to (4) are suitable.

(1) A compound in which one end thereof is represented by the following general formula (A-1-i), and the remaining end is represented by the following general formula (A-1-ii).

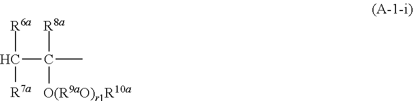

In the formula, R^{6a}, R^{7a}, and R^{8a} each independently represent a hydrogen atom or a hydrocarbon group having 1 to 8 carbon atoms, and they may be the same as or different from each other; R^{9a} represents a divalent hydrocarbon group having 2 to 10 carbon atoms; R^{10a} represents a hydrocarbon group having 1 to 10 carbon atoms; r1 represents a number of 0 to 10 in terms of an average value thereof and in the case where plural R⁹aO's are present, the plural R⁹aO's may be the same as or different from each other.

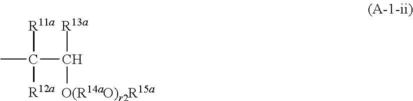

In the formula, R^{11a}, R^{12a}, and R^{13a} each independently represent a hydrogen atom or a hydrocarbon group having 1 to 8 carbon atoms, and they may be the same as or different from each other; R^{14a} represents a divalent hydrocarbon group having 2 to 10 carbon atoms; R^{15a} represents a hydrocarbon group having 1 to 10 carbon atoms; r2 represents a number of 0 to 10 in terms of an average value thereof and in the case where plural R¹⁴aO's are present, the plural R¹⁴aO's may be the same as or different from each other.

(2) A compound in which one end thereof is represented by the foregoing general formula (A-1-i), and the remaining end is represented by the following general formula (A-1-iii).

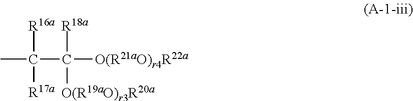

In the formula, R^{16a}, R^{17a}, and R^{18a} each independently represent a hydrogen atom or a hydrocarbon group having 1 to 8 carbon atoms, and they may be the same as or different from each other; R^{19a} and R^{21a} each independently represent a divalent hydrocarbon group having 2 to 10 carbon atoms, and they may be the same as or different from each other; R^{20a} and R^{22a} each independently represent a hydrocarbon group having 1 to 10 carbon atoms, and they may be the same as or different from each other; r3 and r4 each represent a number of 0 to 10 in terms of an average value thereof, and they may be the same as or different from each other; in the case where plural R¹⁹aO's are present, the plural R¹⁹aO's may be the same as or different from each other; and in the case where plural R^{21a}O's are present, the plural R²¹aO's may be the same as or different from each other.

(3) A compound in which one end thereof is represented by the foregoing general formula (A-1-i), and the remaining end has an olefinic unsaturated bond:

(4) A compound in which one end thereof is represented by the foregoing general formula (A-1-i), and the remaining end is represented by the following general formula (A-1-iv).

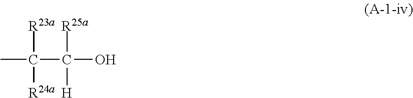

In the formula, R^{23a}, R^{24a}, and R^{25a} each independently represent a hydrogen atom or a hydrocarbon group having 1 to 8 carbon atoms, and they may be the same as or different from each other.

As the hydrocarbon group having 1 to 8 carbon atoms as represented by R^{6a}, R^{7a}, and R^{8a} in the general formula (A-1-i), R^{11a}, R^{12a}, and R^{13a} in the general formula (A-1-ii), R^{16a}, R^{17a}, and R^{18a} in the general formula (A-1-iii), and R^{23a}, R^{24a}, and R^{25a} in the general formula (A-1-iv), there are exemplified the same hydrocarbon groups as those exemplified as the hydrocarbon group having 1 to 8 carbon atoms as represented by R^{1a}, R^{2a}, and R^{3a} in the general formula (A-1).

As the divalent hydrocarbon group having 2 to 10 carbon atoms as represented by R^{9a} in the general formula (A-1-i), R^{14a} in the general formula (A-1-ii), and R^{19a} and R^{21a} in the general formula (A-1-iii), there are exemplified the same hydrocarbon groups as those exemplified as the divalent hydrocarbon group having 2 to 10 carbon atoms as represented by R^{4a} in the general formula (A-1).

As the hydrocarbon group having 1 to 10 carbon atoms as represented by R^{10a} in the general formula (A-1-i), R^{15a} in the general formula (A-1-ii), and R^{20a} and R^{22a} in the general formula (A-1-iii), there are exemplified the same hydrocarbon groups as those exemplified as the hydrocarbon group having 1 to 10 carbon atoms as represented by R^{5a} in the general formula (A-1).

The polyvinyl ether compound may also be a mixture of two or more selected from those having an end structure of any of the foregoing (1) to (4). Examples of such a mixture include a mixture of the compound having the end structure of the foregoing (1) and the compound having the end structure of the foregoing (4); and a mixture of the compound having the end structure of the foregoing (2) and the compound having the end structure of the foregoing (3).

As for the polyvinyl ether compound, it is preferred to choose a degree of polymerization, an end structure, and so on so as to have a preferred viscosity range of the base oil as mentioned later. In addition, the polyvinyl ether compound may be used solely, or may be used in combination of two or more thereof.

Of the polyvinyl ether compounds having the constituent unit represented by the general formula (A-1), in particular, a compound in which one end thereof is represented by the general formula (A-1-i), and the remaining end is represented by the general formula (A-1-ii) is preferred.

Above all, it is more preferred that in the formulae (A-1-i) and (A-1-ii), all of R^{6a}, R^{7a}, R^{8a}, R^{11a}, R^{12a}, and R^{13a} are a hydrogen atom, all of r1 and r2 are 0, and R^{10a} and R^{15a} are each an alkyl group having 1 to 4 carbon atoms.

### <Polyoxyalkylene Glycol Compound (PAG)>

Examples of the polyoxyalkylene glycol compound (PAG) include a compound represented by the following general formula (B-1). In the case where PAG is contained in the base oil, the PAG may be used either solely or in combination of two or more thereof.

R^{1b}—[(OR^{2b})ₘ—OR^{3b}]ₙ (B-1)

In the formula, R^{1b} represents a hydrogen atom, a monovalent hydrocarbon group having 1 to 10 carbon atoms, an acyl group having 2 to 10 carbon atoms, a hydrocarbon group having 2 to 6 bonding sites and having 1 to 10 carbon atoms, or an oxygen-containing hydrocarbon group having 1 to 10 carbon atoms; R^{2b} represents an alkylene group having 2 to 4 carbon atoms; R^{3b} represents a hydrogen atom, a hydrocarbon group having 1 to 10 carbon atoms, an acyl group having 2 to 10 carbon atoms, or an oxygen-containing hydrocarbon group having 1 to 10 carbon atoms; n represents an integer of 1 to 6; and m represents a number such that an average value of (m×n) is 6 to 80.

In the general formula (B-1), the monovalent hydrocarbon group having 1 to 10 carbon atoms in each of R^{1b} and R^{3b} may be any of straight-chain, branched, and cyclic groups. The hydrocarbon group is preferably an alkyl group, and specific examples thereof include a methyl group, an ethyl group, a n-propyl group, an isopropyl group, a butyl group of every kind, a pentyl group of every kind, a hexyl group of every kind, a heptyl group of every kind, an octyl group of every kind, a nonyl group of every kind, a decyl group of every kind, a cyclopentyl group, a cyclohexyl group, and the like. As for the aforementioned monovalent hydrocarbon group, when the number of carbon atoms is 10 or less, the compatibility with the refrigerant becomes good. From such a viewpoint, the number of carbon atoms of the monovalent hydrocarbon group is preferably 1 to 4.

The hydrocarbon group moiety which the acyl group having 2 to 10 carbon atoms in each of R^{1b} and R^{3b} has may be any of straight-chain, branched, and cyclic groups. The hydrocarbon group moiety of the acyl group is preferably an alkyl group, and specific examples thereof include those having 1 to 9 carbon atoms among the alkyl groups which may be chosen as the aforementioned R^{1b} and R^{3b}. When the number of carbon atoms of the acyl group is 10 or less, the compatibility with the refrigerant becomes good. From such a viewpoint, the number of carbon atoms of the acyl group is preferably 2 to 4.

In the case where all of R^{1b} and R^{3b} are a hydrocarbon group or an acyl group, R^{1b} and R^{3b} may be the same as or different from each other.

Furthermore, in the case where n is 2 or more, plural R^{3b}'s in one molecule may be the same as or different from each other.

In the case where R^{1b} is the hydrocarbon group having 2 to 6 bonding sites and having 1 to 10 carbon atoms, this hydrocarbon group may be either linear or cyclic.

The hydrocarbon group having 2 bonding sites is preferably an aliphatic hydrocarbon group, and examples thereof include an ethylene group, a propylene group, a butylene group, a pentylene group, a hexylene group, a heptylene group, an octylene group, a nonylene group, a decylene group, a cyclopentylene group, a cyclohexylene group, and the like. Examples of the other hydrocarbon groups may include residues resulting from removing a hydroxy group from a biphenol, bisphenol compound such as bisphenol, bisphenol F, bisphenol A, etc.

The hydrocarbon group having 3 to 6 bonding sites is preferably an aliphatic hydrocarbon group, and examples thereof include residues resulting from removing a hydroxy group from a polyhydric alcohol, such as trimethylolpropane, glycerin, pentaerythritol, sorbitol, 1,2,3-trihydroxycyclohexane, 1,3,5-trihydroxycyclohexane, etc.

When the number of carbon atoms of such an aliphatic hydrocarbon group having 2 to 6 bonding sites is 10 or less, the compatibility with the refrigerant becomes good. From such a viewpoint, the number of carbon atoms of this aliphatic hydrocarbon group is preferably 2 to 6.

Furthermore, examples of the oxygen-containing hydrocarbon group having 1 to 10 carbon atoms in each of R^{1b} and R^{3b} include an ether bond-containing linear aliphatic group or cyclic aliphatic group (for example, a tetrahydrofurfuryl group), and the like.

At least one of R^{1b} and R^{3b} is preferably an alkyl group, and especially preferably an alkyl group having 1 to 4 carbon atoms.

R^{2b} in the general formula (B-1) is an alkylene group having 2 to 4 carbon atoms, and examples of the oxyalkylene group as a repeating unit include an oxyethylene group, an oxypropylene group, and an oxybutylene group. The oxyalkylene groups in one molecule may be the same as each other, and two or more of oxyalkylene groups may also be contained. It is preferred that at least an oxypropylene unit is contained in one molecule, and it is more preferred that 50 mol % or more of an oxypropylene unit is contained in the whole of oxyalkylene units.

In the general formula (B-1), n is an integer of 1 to 6 and is determined according to the number of bonding sites of R^{1b}. For example, in the case where R^{1b} is an alkyl group or an acyl group, then n is 1; and in the case where R^{1b} is an aliphatic hydrocarbon group having 2, 3, 4, 5, or 6 bonding sites, then n is 2, 3, 4, 5, or 6, respectively. m is a number such that an average value of (m×n) is 6 to 80. When the foregoing average value is 80 or less, the compatibility becomes good. In addition, n is preferably an integer of 1 to 3, and more preferably 1. However, it is preferred that the average value of (m×n) is properly set such that a viscosity of the base oil as mentioned later falls within a desired range.

The polyoxyalkylene glycol compound represented by the general formula (B-1) is one inclusive of a polyoxyalkylene glycol having a hydroxy group in an end thereof, and so long as the content of the hydroxy group is a proportion of 50 mol % or less relative to the whole of end groups, even when such a polyoxyalkylene glycol is contained, it can be suitably used.

### <Copolymer of Poly(Oxy)Alkylene Glycol or Monoether Thereof and Polyvinyl Ether (ECP)>

In the refrigerator oil of the present embodiment, examples of the copolymer of a poly(oxy)alkylene glycol or a monoether thereof and polyvinyl ether that can be used as the base oil include a copolymer represented by the following general formula (C-1) and a copolymer represented by the following general formula (C-2) (hereinafter referred to as “polyvinyl ether copolymer I” and “polyvinyl ether copolymer II”, respectively). The poly(oxy)alkylene glycol refers to both a polyalkylene glycol and a polyoxyalkylene glycol.

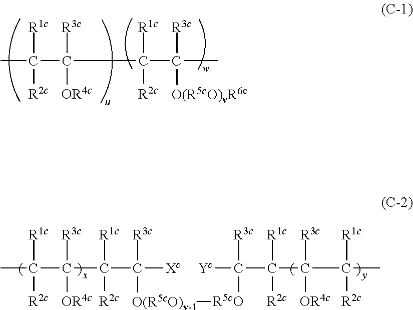

In the general formula (C-1), R^{1c}, R^{2c}, and R^{3c} each independently represent a hydrogen atom or a hydrocarbon group having 1 to 8 carbon atoms, and they may be the same as or different from each other; R^{5c} represents a divalent hydrocarbon group having 2 to 4 carbon atoms; R^{6c} represents an aliphatic or alicyclic hydrocarbon group having 1 to 20 carbon atoms, an aromatic hydrocarbon group having 1 to 20 carbon atoms, an acyl group having 2 to 20 carbon atoms, or an oxygen-containing hydrocarbon group having 2 to 50 carbon atoms; R^{4c} represents a hydrocarbon group having 1 to 10 carbon atoms; and in the case where a plurality of each of R^{1c} to R^{6c} are present, they may be each the same as or different from each other.

Here, specifically, examples of the hydrocarbon group having 1 to 8 carbon atoms in R^{1c} to R^{3c} include an alkyl group, such as a methyl group, an ethyl group, a n-propyl group, an isopropyl group, a n-butyl group, an isobutyl group, a sec-butyl group, a tert-butyl group, a pentyl group of every kind, a hexyl group of every kind, a heptyl group of every kind, an octyl group of every kind, etc.; a cycloalkyl group, such as a cyclopentyl group, a cyclohexyl group, a methylcyclohexyl group of every kind, an ethylcyclohexyl group of every kind, a dimethylcyclohexyl group of every kind, etc.; an aryl group, such as a dimethylphenyl group of every kind, etc.; and an arylalkyl group, such as a benzyl group, a phenylethyl group of every kind, a methylbenzyl group of every kind, etc. In particular, R^{1c}, R^{2c}, and R^{3c} are each preferably a hydrogen atom.

Meanwhile, specifically, examples of the divalent hydrocarbon group having 2 to 4 carbon atoms as represented by R^{5c} include a divalent alkylene group, such as a methylene group, an ethylene group, a propylene group of every kind, a butylene group of every kind, etc.

In the general formula (C-1), v represents a repeating number of R^{5c}O, and is a number of 1 to 50, preferably 1 to 20, more preferably 1 to 10, and still more preferably 1 to 5 in terms of an average value thereof. In the case where plural R^{5c}O's are present, the plural R^{5c}O's may be the same as or different from each other. v may be the same as or different from each other in every constituent unit.

w represents a number of 1 to 50, preferably 1 to 10, more preferably 1 to 2, and still more preferably 1.

In the general formula (C-1), u represents a number of 0 to 50, preferably 2 to 25, and more preferably 5 to 15.

In the case where a plurality of each of w and u are present, they may be either block or random.

Furthermore, in the general formula (C-1), R^{6c} preferably represents an alkyl group having 1 to 10 carbon atoms, an acyl group having 2 to 10 carbon atoms, or an oxygen-containing hydrocarbon group having 2 to 50 carbon atoms.

Specifically, examples of this alkyl group having 1 to 10 carbon atoms include a methyl group, an ethyl group, a n-propyl group, an isopropyl group, a n-butyl group, an isobutyl group, a sec-butyl group, a tert-butyl group, a pentyl group of every kind, a hexyl group of every kind, a heptyl group of every kind, an octyl group of every kind, a nonyl group of every kind, a decyl group of every kind, a cyclopentyl group, a cyclohexyl group, a methylcyclohexyl group of every kind, an ethylcyclohexyl group of every kind, a propylcyclohexyl group of every kind, a dimethylcyclohexyl group of every kind, and the like.

Examples of the acyl group having 2 to 10 carbon atoms include an acetyl group, a propionyl group, a butyryl group, an isobutyryl group, a valeryl group, an isovaleryl group, a pivaloyl group, a benzoyl group, a toluoyl group, and the like.

Furthermore, as specific examples of the oxygen-containing hydrocarbon group having 2 to 50 carbon atoms, there are preferably exemplified a methoxymethyl group, a methoxyethyl group, a methoxypropyl group, a 1,1-bismethoxypropyl group, a 1,2-bismethoxypropyl group, an ethoxypropyl group, a (2-methoxyethoxy)propyl group, a (1-methyl-2-methoxy)propyl group, and the like.

In the general formula (C-1), specifically, examples of the hydrocarbon group having 1 to 10 carbon atoms as represented by R^{4c} include an alkyl group, such as a methyl group, an ethyl group, a n-propyl group, an isopropyl group, a n-butyl group, an isobutyl group, a pentyl group of every kind, a hexyl group of every kind, a heptyl group of every kind, an octyl group of every kind, a nonyl group of every kind, a decyl group of every kind, etc.; a cycloalkyl group, such as a cyclopentyl group, a cyclohexyl group, a methylcyclohexyl group of every kind, an ethylcyclohexyl group of every kind, a propylcyclohexyl group of every kind, a dimethylcyclohexyl group of every kind, etc.; an aryl group, such as a phenyl group, a methylphenyl group of every kind, an ethylphenyl group of every kind, a dimethylphenyl group of every kind, a propylphenyl group of every kind, a trimethylphenyl group of every kind, a butylphenyl group of every kind, a naphthyl group of every kind, etc.; an arylalkyl group, such as a benzyl group, a phenylethyl group of every kind, a methylbenzyl group of every kind, a phenylpropyl group of every kind, a phenylbutyl group of every kind, etc.; and the like.

The polyvinyl ether copolymer I having the constituent unit represented by the general formula (C-1) is able to improve lubricating properties, insulating properties, hygroscopicity, and so on while satisfying the compatibility through formation of the copolymer.

Meanwhile, in the polyvinyl ether copolymer II represented by the general formula (C-2), R^{1c} to R^{5c} and v are the same as those mentioned above. In the case where a plurality of each of R^{4c} and R^{5c} are present, they may be each the same as or different from each other. x and y each represent a number of 1 to 50, and in the case where a plurality of each of x and y are present, they may be either block or random. X_{c} and Y^{c} each independently represent a hydrogen atom, a hydroxy group, or a hydrocarbon group having 1 to 20 carbon atoms.

It is preferred that the repeating numbers u, w, x, and y in the general formulae (C-1) and (C-2) are properly chosen such that a desired viscosity as mentioned later is obtained. In addition, a production method of each of the polyvinyl ether copolymers I and II is not particularly limited so long as it is a method for which each of the polyvinyl ether copolymers I and II is obtained.

The vinyl ether-based copolymer I represented by the general formula (C-1) can be formed into the polyvinyl ether copolymer I having a structure in which one end thereof is represented by the following general formula (C-3) or (C-4), and the remaining end is represented by the following general formula (C-5) or (C-6).

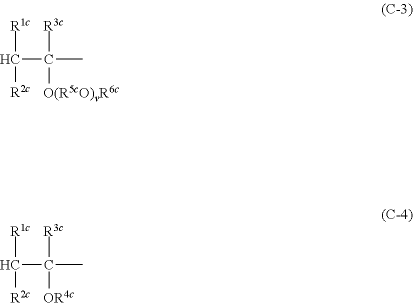

In the aforementioned (C-3) and (C-4), R^{1c} to R^{6c} and v are the same as those as mentioned above.

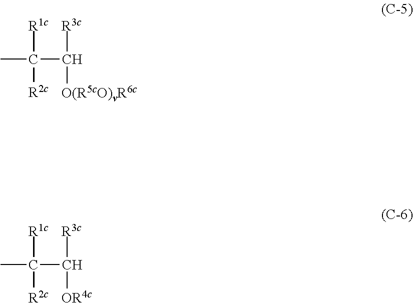

In the aforementioned (C-5) and (C-6), R^{1c} to R^{6c} and v are the same as those as mentioned above.

### <Polyol Ester Compound (POE)>

In the refrigerator oil, as the polyol ester compound that can be used as the base oil, for example, an ester of a diol or a polyol having 3 to 20 hydroxy groups and a fatty acid having 1 to 24 carbon atoms is preferred.

Here, examples of the diol include ethylene glycol, 1,3-propanediol, propylene glycol, 1,4-butanediol, 1,2-butanediol, 2-methyl-1,3-propanediol, 1,5-pentanediol, neopentyl glycol, 1,6-hexanediol, 2-ethyl-2-methyl-1,3-propanediol, 1,7-heptanediol, 2-methyl-2-propyl-1,3-propanediol, 2,2-diethyl-1,3-propanediol, 1,8-octanediol, 1,9-nonanediol, 1,10-decanediol, 1,11-undecanediol, 1,12-dodecanediol, and the like.

Examples of the polyol include a polyhydric alcohol, such as trimethylolethane, trimethylolpropane, trimethylolbutane, di-(trimethylolpropane), tri-(trimethylolpropane), pentaerythritol, di-(pentaerythritol), tri-(pentaerythritol), glycerin, a polyglycerin (e.g., dimer to icosamer of glycerin), 1,3,5-pentanetriol, sorbitol, sorbitan, a sorbitol glycerin condensate, adonitol, arabitol, xylitol, mannitol, etc.; a saccharide, such as xylose, arabinose, ribose, rhamnose, glucose, fructose, galactose, mannose, sorbose, cellobiose, maltose, isomaltose, trehalose, sucrose, raffinose, gentianose, merenditose, etc.; a partially etherified product thereof; a methyl glucoside (a glucoside); and the like. Above all, hindered alcohols, such as neopentyl glycol, trimethylolethane, trimethylolpropane, trimethylolbutane, di-(trimethylolpropane), tri-(trimethylolpropane), pentaerythritol, di-(pentaerythritol), tri-(pentaerythritol), etc., are preferred as the polyol.

As for the fatty acid, though the number of carbon atoms is not particularly limited, those having 1 to 24 carbon atoms are typically used. Of the fatty acids having 1 to 24 carbon atoms, those having 3 or more carbon atoms are preferred, those having 4 or more carbon atoms are more preferred, and those having 5 or more carbon atoms are still more preferred from the standpoint of lubricating properties. In addition, those having 18 or less carbon atoms are preferred, those having 12 or less carbon atoms are more preferred, and those having 9 or less carbon atoms are still more preferred from the standpoint of compatibility with the refrigerant.

The fatty acid may be any of a straight-chain fatty acid and a branched fatty acid, a straight-chain fatty acid is preferred from the standpoint of lubricating properties, and a branched fatty acid is preferred from the standpoint of hydrolysis stability. Furthermore, the fatty acid may be any of a saturated fatty acid and an unsaturated fatty acid.

Examples of the fatty acid include a straight-chain or branched fatty acid, such as isobutyric acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, oleic acid, etc.; a so-called neo acid in which an α-carbon atom is quaternary; and the like. More specifically, isobutyric acid, valeric acid (n-pentanoic acid), caproic acid (n-hexanoic acid), enanthic acid (n-heptanoic acid), caprylic acid (n-octanoic acid), pelargonic acid (n-nonanoic acid), capric acid (n-decanoic acid), oleic acid (cis-9-octadecenoic acid), isopentanoic acid (3-methylbutanoic acid), 2-methylhexanoic acid, 2-ethylpentanoic acid, 2-ethylhexanoic acid, 3,5,5-trimethylhexanoic acid, and the like are preferred.

The polyol ester may also be a partial ester in which some of the hydroxy groups of a polyol remain without being esterified, may be a complete ester in which all of the hydroxy groups of the polyol are esterified, or may be a mixture of the partial ester and the complete ester, but the polyol ester is preferably the complete ester.

Of those polyol esters, an ester of a hindered alcohol, such as neopentyl glycol, trimethylolethane, trimethylolpropane, trimethylolbutane, di-(trimethylolpropane), tri-(trimethylolpropane), pentaerythritol, di-(pentaerythritol), tri-(pentaerythritol), etc., is preferred, and an ester of neopentyl glycol, trimethylolethane, trimethylolpropane, trimethylolbutane, or pentaerythritol is more preferred, because such an ester is more excellent in hydrolysis stability. An ester of pentaerythritol is still more preferred because it is especially excellent in compatibility with the refrigerant and hydrolysis stability.

Specific examples of the preferred polyol ester include a diester of neopentyl glycol and one or more fatty acids selected from isobutyric acid, valeric acid, caproic acid, enanthic acid, caprylic acid, pelargonic acid, capric acid, oleic acid, isopentanoic acid, 2-methylhexanoic acid, 2-ethylpentanoic acid, 2-ethylhexanoic acid, and 3,5,5-trimethylhexanoic acid; a triester of trimethylolethane and one or more fatty acids selected from isobutyric acid, valeric acid, caproic acid, enanthic acid, caprylic acid, pelargonic acid, capric acid, oleic acid, isopentanoic acid, 2-methylhexanoic acid, 2-ethylpentanoic acid, 2-ethylhexanoic acid, and 3,5,5-trimethylhexanoic acid; a triester of trimethylolpropane and one or more fatty acids selected from isobutyric acid, valeric acid, caproic acid, enanthic acid, caprylic acid, pelargonic acid, capric acid, oleic acid, isopentanoic acid, 2-methylhexanoic acid, 2-ethylpentanoic acid, 2-ethylhexanoic acid, and 3,5,5-trimethylhexanoic acid; a triester of trimethylolbutane and one or more fatty acids selected from isobutyric acid, valeric acid, caproic acid, enanthic acid, caprylic acid, pelargonic acid, capric acid, oleic acid, isopentanoic acid, 2-methylhexanoic acid, 2-ethylpentanoic acid, 2-ethylhexanoic acid, and 3,5,5-trimethylhexanoic acid; and a tetraester of pentaerythritol and one or more fatty acids selected from isobutyric acid, valeric acid, caproic acid, enanthic acid, caprylic acid, pelargonic acid, capric acid, oleic acid, isopentanoic acid, 2-methylhexanoic acid, 2-ethylpentanoic acid, 2-ethylhexanoic acid, and 3,5,5-trimethylhexanoic acid.

The ester of two or more fatty acids may be a mixture of two or more esters of one fatty acid and a polyol, and it may also be an ester of a mixed fatty acid of two or more thereof and a polyol. Particularly, an ester of a mixed fatty acid and a polyol is excellent in low-temperature properties and compatibility with the refrigerant.

It is preferred that a kinematic viscosity at 100° C. of the oxygen-containing organic compound that is contained in the refrigerator oil is 1 to 30 mm²/s. When this kinematic viscosity is 1 mm²/s or more, not only a good lubricating performance is exhibited, but also sealing properties are good. In addition, when the kinematic viscosity is 30 mm²/s or less, the compatibility between the refrigerant and the refrigerator oil is excellent, and energy saving properties are good. From the foregoing viewpoints, the kinematic viscosity at 100° C. of the oxygen-containing organic compound is more preferably 2 to 20 mm²/s, and still more preferably 3 to 15 mm²/s.

So long as the object of the present invention is not impaired, the base oil may be one composed of only the aforementioned oxygen-containing organic compound; however, the base oil may contain, in addition to the oxygen-containing organic compound, a mineral oil or a synthetic oil other than the aforementioned oxygen-containing organic compound, or both of them. The content of the base oil other than the aforementioned oxygen-containing organic compound is preferably less than 10 mass %, more preferably less than 5 mass %, and still more preferably less than 1 mass % relative to the whole amount of the refrigerator oil. Similar to the oxygen-containing organic compound, the base oil other than the oxygen-containing organic compound has a kinematic viscosity at 100° C. of preferably 1 to 30 mm²/s, more preferably 2 to 20 mm²/s, and still more preferably 3 to 15 mm²/s.

### [Polyphosphate Ester-Based Compound]

The polyphosphate ester-based compound that is contained in the refrigerator oil of the present embodiment is a phosphate ester compound having at least two phosphate skeletons in one molecule thereof.

In the present embodiment, by incorporating the polyphosphate ester-based compound and a polyhydric alcohol as mentioned later, it becomes possible to reduce the coefficient of friction in a sliding portion of the refrigerator while making the wear resistance good.

The polyphosphate ester-based compound may be used solely, or may be used in combination of two or more thereof.

Specifically, a compound presented by the following general formula (1) is preferred as the polyphosphate ester-based compound.

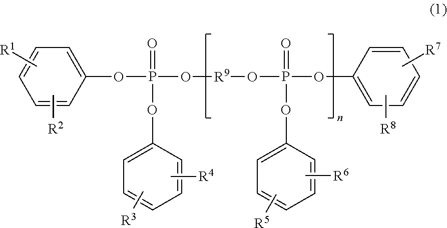

In the formula (1), n represents an integer of 1 to 10; R¹ to R⁸ each independently represent a hydrogen atom or an alkyl group having 1 to 20 carbon atoms; and R⁹ represents a divalent hydrocarbon group having 2 to 20 carbon atoms.

In the general formula (1), the alkyl group in each of R¹ to R⁸ may be any of straight-chain, branched, and cyclic groups, and examples thereof include a methyl group, an ethyl group, a n-propyl group, an isopropyl group, a butyl group of every kind, a pentyl group of every kind, a hexyl group of every kind, a heptyl group of every kind, an octyl group of every kind, a nonyl group of every kind, a decyl group of every kind, an undecyl group of every kind, a dodecyl group of every kind, a tridecyl group of every kind, a tetradecyl group of every kind, a pentadecyl group of every kind, a hexadecyl group of every kind, a heptadecyl group of every kind, an octadecyl group of every kind, and the like.

R¹ to R⁸ are each preferably a hydrogen atom or an alkyl group having 1 to 4 carbon atoms, more preferably a hydrogen atom or a methyl group, and still more preferably a hydrogen atom.

In the general formula (1), R⁹ is preferably an alkylene group, an arylene group, or a hydrocarbon group composed of an arylene group and an alkylene group, and it is more preferred that R⁹ contains an arylene group. Here, in the case where R⁹ is an alkylene group, examples of the alkylene group include an ethylene group, a propylene group, a butylene group, a pentylene group, a hexylene group, a heptylene group, an octylene group, a nonylene group, a decylene group, an undecylene group, a dodecylene group, a tetradecylene group, a hexadecylene group, an octadecylene group, an icosalene group, and the like; these alkylene groups may be a straight-chain alkylene group, or may be a branched alkylene group of every kind. In addition, the alkylene group may also be a cyclic alkylene group, such as a cyclopropylene group, a cyclobutylene group, a cyclopentylene group, a cyclohexylene group, a cycloheptylene group, a cyclooctylene group, a dicyclopentylene group, a tricyclopentylene group, etc. In addition, as the alkylene group as referred to herein, an alkylidene group is also included.

Though the arylene group may be either substituted or unsubstituted, it is preferably unsubstituted. Specifically, examples of the arylene group include a substituted or unsubstituted phenylene group, a substituted or unsubstituted naphthylene group, a substituted or unsubstituted biphenylene group, and the like. Of those, a substituted or unsubstituted phenylene group is preferred.

Furthermore, in the case where R⁹ is a hydrocarbon group composed of an arylene group and an alkylene group, as each of the arylene group and the alkylene group constituting the hydrocarbon group, the same groups as those mentioned above are exemplified. Above all, as the alkylene group, a straight-chained, branched, or cyclic alkylene group having 1 to 14 carbon atoms is preferred, and a straight-chained or branched alkylene group having 1 to 5 carbon atoms is more preferred. Specifically, examples of the straight-chained or branched alkylene group having 1 to 5 carbon atoms include a methylene group, an ethylene group of every kind, such as 1,1-ethylene group, 1,2-ethylene group, etc., a propylene group of every kind, such as 1,3-propylene group, 1,2-propylene group, 2,2-propylene group, etc.; a butylene group of every kind, and a pentylene group of every kind. Of those, a 2,2-propylene group (—C(CH₃)₂—) is more preferred.

In the general formula (1), n is preferably 1 to 8, more preferably 1 to 5, still more preferably 1 to 3, and especially preferably 1. When n is made small, the molecular weight becomes small. Therefore, the solubility in the base oil is easily increased, and furthermore, the coefficient of friction is easily reduced. The polyphosphate ester-based compound may be a single material in which n is composed of a specified single kind, or it may be a mixture in which n is composed of specified two or more kinds.

As suitable specific examples of R⁹, though a group represented by any of the following general formulae (2) to (4) is preferred, a group represented by the general formula (2) or (3) is more preferred, and a group represented by the general formula (2) is still more preferred. The general formula (2) may be any of ortho, meta, and para, with meta being preferred.

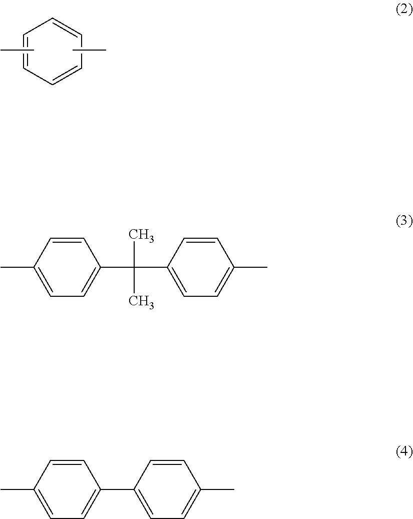

Specific examples of the preferred polyphosphate ester-based compound include compounds represented by the following general formula (5) or (6). Of those, a compound represented by the following general formula (5) is more preferred.

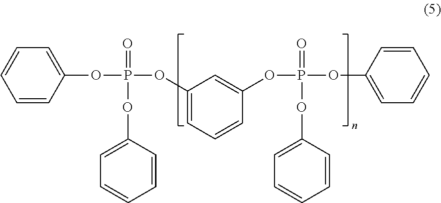

In the formula (5), n represents an integer of 1 to 10, preferably 1 to 8, more preferably 1 to 5, and still more preferably 1 to 3.

In the case where the base oil contains PVE as the aforementioned oxygen-containing organic compound, the polyphosphate ester-based compound represented by the general formula (5) easily exhibits the effect for reducing the coefficient of friction while making the wear resistance good, and in the case where n is 1 to 3, particularly in the case where n is 1, the foregoing effect is easily exhibited.

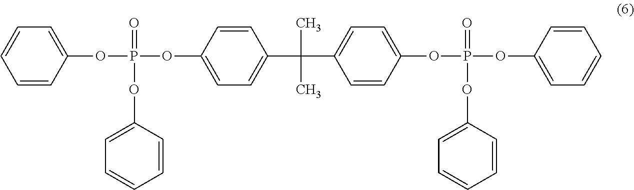

The content of the polyphosphate ester-based compound is preferably 0.01 to 5.0 mass % relative to the whole amount of the refrigerator oil. In the present embodiment, by incorporating the polyphosphate ester-based compound in an amount of 0.01 mass % or more, it is possible to effectively reduce the coefficient of friction in a sliding portion while maintaining the stability and wear resistance of the refrigerator oil good. In addition, by controlling the content of the polyphosphate ester-based compound to 5.0 mass % or less, it becomes easy to dissolve the polyphosphate ester-based compound in the base oil, and the effect corresponding to the amount is easily exhibited.

In order to effectively reduce the coefficient of friction in a sliding portion while taking into consideration the stability and wear resistance of the refrigerator oil, the content of the polyphosphate ester-based compound is more preferably 0.5 to 5.0 mass %, still more preferably 1.0 to 5.0 mass %, and especially preferably 1.0 to 3.0 mass % relative to the whole amount of the refrigerator oil.

### [Polyhydric Alcohol]

The refrigerator oil of the present embodiment contains, in addition to the polyphosphate ester-based compound, a polyhydric alcohol having two or more hydroxy groups. Though the number of hydroxy groups which the polyhydric alcohol has may be 2 or more, it is preferably 2 to 4, and more preferably 2.

Examples of the polyhydric alcohol include a polyhydric alcohol having 2 to 24 carbon atoms. The number of carbon atoms is preferably 4 to 24, and more preferably 4 to 20.

Preferred specific examples of the polyhydric alcohol include one or more selected from a (poly)alkylene glycol-based compound in which the number of carbon atoms of the alkylene group is 2 to 4, and the number of oxyalkylene units in one molecule thereof is 1 to 4. In the present embodiment, by using the (poly)alkylene glycol-based compound, it becomes easy to more reduce the coefficient of friction. The term “(poly)alkylene glycol-based compound” is a concept including both an alkylene glycol and a polyalkylene glycol.

The (poly)alkylene glycol-based compound is a compound having two hydroxy groups, and specific examples thereof include an alkylene glycol in which the number of oxyalkylene units in one molecule thereof is 1, such as ethylene glycol, propylene glycol (1,2-propanediol), 1,3-propanediol, 1,2-butanediol, 1,3-butanediol, 1,4-butanediol, etc.; and a polyalkylene glycol in which the number of oxyalkylene units in one molecule thereof is 2 to 4, such as diethylene glycol, triethylene glycol, tetraethylene glycol, dipropylene glycol, tripropylene glycol, tetrapropylene glycol, dibutylene glycol, tributylene glycol, tetrabutylene glycol, etc.

Of the foregoing, a polyalkylene glycol in which the number of carbon atoms of the alkylene group is 2 to 3, and the number of oxyalkylene units in one molecule thereof is 2 to 3, specifically, diethylene glycol, triethylene glycol, dipropylene glycol, tripropylene glycol, or the like, is preferred. Furthermore, a dialkylene glycol in which the number of carbon atoms of the alkylene group is 3, and the number of oxyalkylene units in one molecule thereof is 2, namely dipropylene glycol, is more preferred.

In the present embodiment, as the polyhydric alcohol, it is also possible to use various alcohols other than the above-exemplified polyhydric alcohols. Examples thereof include a dihydric alcohol, such as 1,5-pentanediol, neopentyl glycol, 1,6-hexanediol, 2-ethyl-2-methyl-1,3-propanediol, 1,7-heptanediol, 2-methyl-2-propyl-1,3-propanediol, 2,2-diethyl-1,3-propanediol, 1,8-octanediol, 1,9-nonanediol, 1,10-decanediol, 1,11-undecanediol, 1,12-dodecanediol, etc.; a trihydric alcohol, such as trimethylolethane, trimethylolpropane, trimethylolbutane, glycerin, etc.; and a tetra or higher polyhydric alcohol, such as pentaerythritol, dip entaerythritol, diglycerin, sorbitol, xylitol, etc.

The polyhydric alcohol may be used solely, or may be used in combination of two or more thereof.

The content of the polyhydric alcohol in the refrigerator oil is preferably 0.01 mass % or more relative to the whole amount of the refrigerator oil. By controlling the content of the polyhydric alcohol to 0.01 mass % or more, it become easy to obtain the effect for reducing the coefficient of friction. In addition, though an upper limit of the content of the polyhydric alcohol is not particularly limited, it is preferably 5 mass % or less relative to the whole amount of the refrigerator oil. By controlling the content of the polyhydric alcohol to 5 mass % or less, it is possible to reduce the coefficient of friction without largely worsening a volume resistivity value of the refrigerator oil.

From the aforementioned viewpoint, the content of the polyhydric alcohol is more preferably 0.03 to 3 mass % relative to the whole amount of the refrigerator oil, and in order to effectively reduce the coefficient of friction, the content of the polyhydric alcohol is still more preferably 0.03 to 2 mass %, especially preferably 0.03 to 1 mass %, and most preferably 0.08 to 0.5 mass %.

### [Other Additives]

The refrigerator oil according to the present embodiment may further contain, in addition to the aforementioned polyphosphate ester-based compound and polyhydric alcohol, one or more various additives, such as an antioxidant, an acid scavenger, an anti-foaming agent, an extreme pressure agent, an oiliness agent, an oxygen scavenger, a metal deactivator, a rust inhibitor, etc. (hereinafter referred to as “other additive”). Above all, it is preferred to contain one or more selected from an antioxidant, an acid scavenger, and an anti-foaming agent. However, the refrigerator oil may not contain the other additive. The other additive than the aforementioned polyphosphate ester-based compound and polyhydric alcohol is contained in an amount of preferably 15 mass % or less, and more preferably 0 to 5 mass % relative to the whole amount of the refrigerator oil.

Examples of the antioxidant include a phenol-based antioxidant, such as 2,6-di-tert-butyl-4-methylphenol, 2,6-di-tert-butyl-4-ethylphenol, 2,2′-methylenebis(4-methyl-6-tert-butylphenol), etc.; and an amine type antioxidant, such as phenyl-α-naphthylamine, N,N′-di-phenyl-p-phenylenediamine, etc., and a phenol-based antioxidant is preferred. From the standpoints of effects and economy, and so on, the content of the antioxidant is typically 0.01 to 5 mass %, and preferably 0.05 to 3 mass % relative to the whole amount of the refrigerator oil.

Examples of the acid scavenger include an epoxy compound, such as phenyl glycidyl ether, an alkyl glycidyl ether, an alkylene glycol glycidyl ether, cyclohexene oxide, an α-olefin oxide, an epoxidized soybean oil, etc. Above all, from the standpoint of compatibility, phenyl glycidyl ether, an alkyl glycidyl ether, an alkylene glycol glycidyl ether, cyclohexene oxide, and an α-olefin oxide are preferred.

The alkyl group in the alkyl glycidyl ether and the alkylene group in the alkylene glycol glycidyl ether may be each any of straight-chained and branched groups, and the number of carbon atoms thereof is typically 3 to 30, preferably 4 to 24, and more preferably 6 to 16.

The α-olefin oxide is one having a total number of carbon atoms of generally 4 to 50, preferably 4 to 24, and more preferably 6 to 16.

In the present embodiment, the acid scavenger may be used solely, or may be used in combination of two or more thereof. In addition, the content thereof is typically 0.005 to 5 mass %, and preferably 0.05 to 3 mass % relative to the whole amount of the refrigerator oil from the standpoints of effects and inhibition of sludge generation.

In the present embodiment, by incorporating the acid scavenger, the stability of the refrigerator oil can be improved.

Examples of the anti-foaming agent include a silicone-based anti-foaming agent, a fluorinated silicone-based anti-foaming agent, and the like. The content of the anti-foaming agent is typically 0.005 to 2 mass %, and preferably 0.01 to 1 mass % relative to the whole amount of the refrigerator oil.

Examples of the extreme pressure agent include a metal salt of an organic carboxylic acid (hereinafter also referred to as “organic carboxylic acid metal salt”). The organic carboxylic acid metal salt as referred to herein is a metal salt of an organic carboxylic acid having preferably 6 to 60 carbon atoms, more preferably 6 to 24 carbon atoms, and still more preferably 16 to 20 carbon atoms.

Examples of the organic carboxylic acid constituting the organic carboxylic acid metal salt include an aliphatic saturated monocarboxylic acid, an aliphatic unsaturated monocarboxylic acid, an aliphatic dicarboxylic acid, an aromatic carboxylic acid, an alicyclic carboxylic acid, and the like.

Furthermore, specific examples thereof are given. Examples of the aliphatic saturated monocarboxylic acid include a straight-chain fatty acid, such as caproic acid, caprylic acid, capric acid, lauric acid, myristic acid, palmitic acid, stearic acid, arachidic acid, cerotic acid, lacceric acid, etc.; and a branched fatty acid, such as 2-methylpentanoic acid, 2,2-dimethylbutanoic acid, 2-methylhexanoic acid, 5-methylhexanoic acid, 2,2-dimethylheptanoic acid, 2-ethyl-2-methylbutanoic acid, 2-ethylhexanoic acid, dimethylhexanoic acid, 2-n-propyl-pentanoic acid, 3,5,5-trimethylhexanoic acid, dimethyloctanoic acid, isotridecanoic acid, isomyristic acid, isostearic acid, isoarachidic acid, isohexanoic acid, etc.

Examples of the aliphatic unsaturated monocarboxylic acid include palmitoleic acid, oleic acid, elaidic acid, linoleic acid, linolenic acid, and the like, as well as an unsaturated hydroxy acid, such as ricinoleic acid, etc. In addition, examples of the aliphatic dicarboxylic acid include adipic acid, azelaic acid, and sebacic acid, and examples of the aromatic carboxylic acid include benzoic acid, phthalic acid, trimellitic acid, pyromellitic acid, and the like. In addition, examples of the alicyclic carboxylic acid include naphthenic acid and the like.

The organic carboxylic acid may also be a dimer acid or trimer acid of a fatty acid of every kind, or the like.

Such an organic carboxylic acid may be used solely, or may be used in combination of two thereof.

Of those, the organic carboxylic acid is preferably an aliphatic saturated monocarboxylic acid having 16 to 20 carbon atoms or an aliphatic unsaturated monocarboxylic acid having 16 to 20 carbon atoms, and above all, an aliphatic unsaturated monocarboxylic acid, such as oleic acid, etc., is more preferred.

Specifically, examples of the metal constituting the organic carboxylic acid metal salt include an alkali metal, such as lithium, potassium, sodium, etc.; an alkaline earth metal, such as magnesium, calcium, strontium, etc.; and other metal, such as zinc, nickel, aluminum, etc. The metal is preferably an alkali metal or an alkaline earth metal, more preferably an alkali metal, and still more preferably potassium. Such a metal may be used either solely or in combination of two or more thereof.

Of those mentioned above, as specific examples of the organic carboxylic acid metal salt, potassium oleate is especially preferred. By incorporating the organic carboxylic acid metal salt, such as potassium oleate, etc., as the extreme pressure agent, it becomes easy to more improve the coefficient of friction of the refrigerator oil.

Meanwhile, the refrigerator oil of the present embodiment has an excellent coefficient of friction, and therefore, it may not substantially contain the organic carboxylic acid metal salt, specifically the aforementioned metal salt of an organic carboxylic acid having 6 to 60 carbon atoms, and especially potassium oleate. The wording “not substantially contain” means the matter that the organic carboxylic acid metal salt may be contained so long as its content is less than 1 ppm in concentration of the metal content derived from the organic carboxylic acid metal salt relative to the whole amount (mass) of the refrigerator oil; however, the organic carboxylic acid metal salt may not be contained at all. When the refrigerator oil does not substantially contain the organic carboxylic acid metal salt, it is possible to prevent the matter that the organic carboxylic acid metal salt causes clogging from occurring.

Examples of the extreme pressure agent other than the organic carboxylic acid metal salt include a phosphorus-based extreme pressure agent, such as a phosphate ester, an acidic phosphate ester, a phosphite ester, an acidic phosphite ester, and an amine salt thereof, etc.

Such a phosphorus-based extreme pressure agent is one having one phosphorus atom in a molecule thereof, and examples thereof include tricresyl phosphate, trithiophenyl phosphate, tri(nonylphenyl) phosphite, dioleyl hydrogenphosphite, 2-ethylhexyldiphenyl phosphite, and the like.

Furthermore, examples of the extreme pressure agent other than those mentioned above include a sulfur-based extreme pressure agent, such as sulfurized fats and oils, a sulfurized fatty acid, a sulfurized ester, a sulfurized olefin, a dihydrocarbyl polysulfide, a thiocarbamate compound, a thioterpene compound, a dialkyl thiodipropionate compound, etc.

The content of the extreme pressure agent is typically 0.0005 to 5 mass %, and preferably 0.001 to 3 mass % relative to the whole amount of the refrigerator oil from the standpoints of lubricating properties and stability.

The extreme pressure agent may be used solely, or may be used in combination of two or more thereof.

Examples of the oiliness agent include an aliphatic saturated or unsaturated monocarboxylic acid, such as stearic acid, oleic acid, etc.; a polymerized fatty acid, such as a dimer acid, a hydrogenated dimer acid, etc.; a hydroxy fatty acid, such as ricinoleic acid, 12-hydroxystearic acid, etc.; an aliphatic saturated or unsaturated monoalcohol, such as lauryl alcohol, oleyl alcohol, etc.; an aliphatic saturated or unsaturated monoamine, such as stearylamine, oleylamine, etc.; an aliphatic saturated or unsaturated monocarboxylic acid amide, such as lauric acid amide, oleic acid amide, etc.; a partial ester of a polyhydric alcohol, such as glycerin, sorbitol, etc., and an aliphatic saturated or unsaturated monocarboxylic acid; and the like.

Such an oiliness agent may be used solely, or may be used in combination of two or more thereof. The content of the oiliness agent is typically 0.01 to 10 mass %, and preferably from 0.1 to 5 mass % relative to the whole amount of the refrigerator oil.

Examples of the oxygen scavenger include a sulfur-containing aromatic compound, such as 4,4′-thiobis(3-methyl-6-t-butylphenol), diphenyl sulfide, dioctyldiphenyl sulfide, a dialkyldiphenylene sulfide, benzothiophene, dibenzothiophene, phenothiazine, benzothiapyrane, thiapyrane, thianthrene, dibenzothiapyrane, diphenylene disulfide, etc.; an aliphatic unsaturated compound, such as various olefins, dienes, and trienes, etc.; a terpene compound having a double bond; and the like.

Examples of the metal deactivator include an N—[N,N′-dialkyl(alkyl group having 3 to 12 carbon atoms)aminomethyl]triazole, and the like.

Examples of the rust inhibitor include a metal sulfonate, an aliphatic amine compound, an organic phosphite ester, an organic phosphate ester, an organic sulfonic acid metal salt, an organic phosphoric acid metal salt, an alkenyl succinate ester, a polyhydric alcohol ester, and the like.

The refrigerator oil according to the present embodiment may further contain various other known additives other than those mentioned above within the range where the object of the present invention is not impaired.

### [Refrigerant]

The refrigerator oil according to the present embodiment is one to be used in the refrigerant environment, and specifically, it is mixed with a refrigerant and used in a refrigerator. That is, in the present embodiment, the refrigerator oil is used in a form of a refrigerator oil composition containing the refrigerator oil and the refrigerant in a refrigerator. In the refrigerator oil composition, as for the use amounts of the refrigerant and the refrigerator oil, a mass ratio of the refrigerant to the refrigerator oil is in a range of preferably from 99/1 to 10/90, and more preferably from 95/5 to 30/70. When this mass ratio falls within the aforementioned range, refrigeration capability and lubricating properties in the refrigerator can be made appropriate.

Examples of the refrigerant that is used include one or more selected from a fluorinated hydrocarbon and, as a natural refrigerant, carbon dioxide, a hydrocarbon, and ammonia.

### <Fluorinated Hydrocarbon>

Examples of the fluorinated hydrocarbon include a saturated fluorinated hydrocarbon compound (saturated HFC) and an unsaturated fluorinated hydrocarbon compound (HFO).

The saturated fluorinated hydrocarbon compound is typically a fluoride of an alkane having 1 to 4 carbon atoms, preferably a fluoride of an alkane having 1 to 3 carbon atoms, and more preferably a fluoride of an alkane having 1 to 2 carbon atoms (methane or ethane). Specifically, examples of the fluoride of methane or ethane include trifluoromethane (R23), difluoromethane (R32), 1,1-difluoroethane (R152a), 1,1,1-trifluoroethane (R143a), 1,1,2-trifluoroethane (R143), 1,1,1,2-tetrafluoroethane (R134a), 1,1,2,2-tetrafluoroethane (R134), and 1,1,1,2,2-pentafluoroethane (R125). Of those, difluoromethane and 1,1,1,2,2-pentafluoroethane are preferred.

Such a saturated fluorinated hydrocarbon compound may be used solely, or may be used in combination of two or more thereof. Examples of the case of using two or more of saturated fluorinated hydrocarbon compounds in combination include a mixed refrigerant of two or more of saturated fluorinated hydrocarbon compounds having 1 to 3 carbon atoms; and a mixed refrigerant of two or more of saturated fluorinated hydrocarbon compounds having 1 to 2 carbon atoms.

Specific examples of the mixed refrigerant include a mixture of R32 and R125 (R410A), a mixture of R125, R143a, and R134a (R404A), a mixture of R32, R125, and R134a (e.g., R407A, R407C, R407E, etc.), a mixture of R125 and R143a (R507A), and the like.

Examples of the unsaturated fluorinated hydrocarbon compound include those having a carbon-carbon double bond, such as a fluoride of a chain olefin having 2 to 6 carbon atoms that is a straight-chain or branched, a fluoride of a cyclic olefin having 4 to 6 carbon atoms, etc.

More specifically, examples thereof include an ethylene having 1 to 3 fluorine atoms introduced thereinto, a propene having 1 to 5 fluorine atoms introduced thereinto, a butene having 1 to 7 fluorine atoms introduced thereinto, a pentene having 1 to 9 fluorine atoms introduced thereinto, a hexene having 1 to 11 fluorine atoms introduced thereinto, a cyclobutene having 1 to 5 fluorine atoms introduced thereinto, a cyclopentene having 1 to 7 fluorine atoms introduced thereinto, a cyclohexene having 1 to 9 fluorine atoms introduced thereinto, and the like.

Of those unsaturated fluorinated hydrocarbon compounds, a fluoride of propene is preferred, a propene having 3 to 5 fluorine atoms introduced thereinto is more preferred, and a propene having 4 fluorine atoms introduced thereinto is still more preferred. Specifically, 1,3,3,3-tetrafluoropropene (HFO1234ze) and 2,3,3,3-tetrafluoropropene (HFO1234yf) are exemplified as a preferred compound.

Such an unsaturated fluorinated hydrocarbon compound may be used solely, or may be used in combination of two or more thereof, and it may be used in combination with other refrigerant than the unsaturated fluorinated hydrocarbon compound. Here, examples of the case of using a combination with other refrigerant than the unsaturated fluorinated hydrocarbon compound include a mixed refrigerant of a saturated fluorinated hydrocarbon compound and an unsaturated fluorinated hydrocarbon compound. Specific examples of the mixed refrigerant include a mixed refrigerant of R-32, HFO1234ze, and R152a (such as AC5; a mixing ratio is 13.23/76.20/9.96) and the like.

### <Natural Refrigerant>

Examples of the natural refrigerant include carbon dioxide (carbonic acid gas), a hydrocarbon, such as propane, n-butane, isobutane, 2-methylbutane, n-pentane, cyclopentane, etc., and ammonia. Such a natural refrigerant may be used solely, or may be used in combination of two or more thereof, and it may be combined with other refrigerant other than the natural refrigerant. Here, examples of the case of using the natural refrigerant in combination with other refrigerant than the natural refrigerant include a saturated fluorinated hydrocarbon compound, an unsaturated fluorinated hydrocarbon compound, and a mixed refrigerant of both of them. Specific examples of the mixed refrigerant include a mixed refrigerant of carbon dioxide, HFO1234ze, and R134a (such as AC6; a mixing ratio is 5.15/79.02/15.41) and the like.

In the present embodiment, of those refrigerants, a fluorinated hydrocarbon is preferred, and a fluorinated hydrocarbon compound is more preferred. Though the refrigerant may be a mixture of a saturated fluorinated hydrocarbon compound and other refrigerant, the refrigerant is preferably one composed of only a saturated fluorinated hydrocarbon compound. Above all, R32, R125, and R410A that is a mixture of R32 and R125 are more preferred, and in particular, it is especially preferred that the refrigerant contains R32. In the case where the refrigerant contains R32, the proportion of R32 in the whole of the refrigerant is preferably 50 mass % or more, and more preferably 70 mass % or more on the basis of the whole amount of the refrigerant, and a refrigerant composed of R32 solely is still more preferred.

### [Refrigerator]

The refrigerator oil or refrigerator oil composition according to the present embodiment is one to be used upon being filled in the interior of a refrigerator. The refrigerator as referred to herein has a refrigeration cycle constituted of essential components including a compressor, a condenser, an expansion mechanism (e.g., an expansion valve, etc.), and an evaporator, or including a compressor, a condenser, an expansion mechanism, a dryer, and an evaporator. The refrigerator oil is one to be used for lubricating a sliding portion provided in, for example, a compressor, etc.

The sliding portion of the refrigerator is preferably a metal-to-metal sliding portion, and examples of the metal of the sliding portion include iron, a steel material, and the like. The refrigerant oil of the present embodiment is able to reduce the coefficient of friction while improving the wear resistance of an iron-to-iron or steel material-to-steel material sliding portion.

More specifically, the aforementioned refrigerator oil and refrigerator oil composition can be used for, for example, various refrigerator systems, hot water systems, and heating systems, such as a car air conditioner, a gas heat pump (GHP), an air conditioner, a fridge, an automatic vending machine, a showcase, a hot water supply machine, a floor heater, etc.

### [Production Method of Refrigerator Oil]

The production method of a refrigerator oil according to an embodiment of the present invention is concerned with a method of blending the aforementioned base oil containing an oxygen-containing organic compound with at least the aforementioned polyphosphate ester-based compound and polyhydric alcohol, to obtain a refrigerator oil. In addition, in the present method, in addition to the polyphosphate ester-based compound and the polyhydric alcohol, one or more selected from the aforementioned various other additives made be blended. Detailed explanations of the base oil, the polyphosphate ester-based compound, the polyhydric alcohol, and the other additives are the same as those as mentioned above, and therefore, their explanations are omitted.

### EXAMPLES

The present invention is hereunder more specifically described by reference to Examples, but it should be construed that the present invention is by no means limited by these Examples. Properties of a base oil and various properties of a refrigerator oil and a refrigerator oil composition were determined according to the following manners.

### (1) Kinematic Viscosity:

The kinematic viscosity was measured using a glass-made capillary viscometer in conformity with JIS K2283:2000.

### (2) Test for Lubricating Properties:

The coefficient of friction and the wear amount in a sliding portion of each refrigerator oil composition were measured in an R32 (difluoromethane) refrigerant environment using a sealing-type block-on-ring friction tester (LFW-1) under the following conditions.
Ring: FC250
Block: SKH51
Number of revolutions: 1,000 rpm
Running-in operation: Load 300 N×1 minute
Load: 500 N
Time: 30 minutes
Oil temperature: 80° C.
Refrigerant pressure: 0.4 MPa

### Examples 1 to 13 and Comparative Examples 1 to 13

A refrigerator oil of each of the Examples and Comparative Examples shown in Table 1 was prepared and subjected to the test for lubricating properties. The results are shown in Table 1.

TABLE 1

| | | Example | | | | | | |
|---|---|---|---|---|---|---|---|---|
| | | 1 | 2 | 3 | 4 | 5 | 6 | 7 |
| Base oil | PVE | 96.25 | 96.20 | 95.80 | 95.30 | 98.20 | 98.20 | 98.20 |
| | PAG | — | — | — | — | — | — | — |
| | ECP | — | — | — | — | — | — | — |
| | POE | — | — | — | — | — | — | — |
| Additive | Polyphosphate | 3.00 | 3.00 | 3.00 | 3.00 | — | — | — |
| | ester-based compound 1 | | | | | | | |
| | Polyphosphate | — | — | — | — | 1.00 | — | — |
| | ester-based compound 2 | | | | | | | |
| | Polyphosphate | — | — | — | — | — | 1.00 | — |
| | ester-based compound 3 | | | | | | | |
| | Polyphosphate | — | — | — | — | — | — | 1.00 |
| | ester-based compound 4 | | | | | | | |
| | Polyhydric alcohol | 0.05 | 0.10 | 0.50 | 1.00 | 0.10 | 0.10 | 0.10 |
| | Antioxidant | 0.30 | 0.30 | 0.30 | 0.30 | 0.30 | 0.30 | 0.30 |
| | Acid scavenger | 0.30 | 0.30 | 0.30 | 0.30 | 0.30 | 0.30 | 0.30 |
| | Anti-foaming agent | 0.10 | 0.10 | 0.10 | 0.10 | 0.10 | 0.10 | 0.10 |
| (Total) | | 100.00 | 100.00 | 100.00 | 100.00 | 100.00 | 100.00 | 100.00 |
| Test for | Coefficient of friction (—) | 0.049 | 0.041 | 0.045 | 0.048 | 0.049 | 0.049 | 0.050 |
| lubricating | Ring wear amount (mg) | 0.2 | 0.1> | 0.1> | 0.1> | 0.2 | 0.1> | 0.1> |
| properties | | | | | | | | |

| | | Example | | | | | |
|---|---|---|---|---|---|---|---|
| | | 8 | 9 | 10 | 11 | 12 | 13 |
| Base oil | PVE | — | — | — | — | — | — |
| | PAG | 96.20 | 96.20 | 96.20 | 96.20 | — | — |
| | ECP | — | — | — | — | 96.20 | — |
| | POE | — | — | — | — | — | 96.20 |
| Additive | Polyphosphate | 3.00 | — | — | — | 3.00 | 3.00 |
| | ester-based compound 1 | | | | | | |
| | Polyphosphate | — | 3.00 | — | — | — | — |
| | ester-based compound 2 | | | | | | |
| | Polyphosphate | — | — | 3.00 | — | — | — |
| | ester-based compound 3 | | | | | | |
| | Polyphosphate | — | — | — | 3.00 | — | — |
| | ester-based compound 4 | | | | | | |
| | Polyhydric alcohol | 0.10 | 0.10 | 0.10 | 0.10 | 0.10 | 0.10 |
| | Antioxidant | 0.30 | 0.30 | 0.30 | 0.30 | 0.30 | 0.30 |
| | Acid scavenger | 0.30 | 0.30 | 0.30 | 0.30 | 0.30 | 0.30 |
| | Anti-foaming agent | 0.10 | 0.10 | 0.10 | 0.10 | 0.10 | 0.10 |
| (Total) | | 100.00 | 100.00 | 100.00 | 100.00 | 100.00 | 100.00 |
| Test for | Coefficient of friction (—) | 0.051 | 0.049 | 0.050 | 0.051 | 0.052 | 0.050 |
| lubricating | Ring wear amount (mg) | 0.1> | 0.1> | 0.1> | 0.1> | 0.1> | 0.1> |
| properties | | | | | | | |

| | | Comparative Example | | | | | | |
|---|---|---|---|---|---|---|---|---|
| | | 1 | 2 | 3 | 4 | 5 | 6 | 7 |
| Base oil | PVE | 99.30 | 98.30 | 96.30 | 98.30 | 98.30 | 98.30 | 99.20 |
| | PAG | — | — | — | — | — | — | — |
| | ECP | — | — | — | — | — | — | — |
| | POE | — | — | — | — | — | — | — |
| Additive | Polyphosphate | — | 1.00 | 3.00 | — | — | — | — |
| | ester-based compound 1 | | | | | | | |
| | Polyphosphate | — | — | — | 1.00 | — | — | — |
| | ester-based compound 2 | | | | | | | |
| | Polyphosphate | — | — | — | — | 1.00 | — | — |
| | ester-based compound 3 | | | | | | | |
| | Polyphosphate | — | — | — | — | — | 1.00 | — |
| | ester-based compound 4 | | | | | | | |
| | Polyhydric alcohol | — | — | — | — | — | — | 0.10 |
| | Antioxidant | 0.30 | 0.30 | 0.30 | 0.30 | 0.30 | 0.30 | 0.30 |
| | Acid scavenger | 0.30 | 0.30 | 0.30 | 0.30 | 0.30 | 0.30 | 0.30 |
| | Anti-foaming agent | 0.10 | 0.10 | 0.10 | 0.10 | 0.10 | 0.10 | 0.10 |
| (Total) | | 100.00 | 100.00 | 100.00 | 100.00 | 100.00 | 100.00 | 100.00 |
| Test for | Coefficient of friction (—) | 0.073 | 0.060 | 0.053 | 0.069 | 0.065 | 0.062 | 0.058 |
| lubricating | Ring wear amount (mg) | 0.4 | 0.2 | 0.1> | 0.1> | 0.1> | 0.1> | 0.5 |
| properties | | | | | | | | |

| | | Comparative Example | | | | | |
|---|---|---|---|---|---|---|---|
| | | 8 | 9 | 10 | 11 | 12 | 13 |
| Base oil | PVE | — | — | — | — | — | — |
| | PAG | 99.30 | 96.30 | — | — | — | — |
| | ECP | — | — | 99.30 | 96.30 | — | — |
| | POE | — | — | — | — | 99.30 | 96.30 |
| Additive | Polyphosphate | — | 3.00 | — | 3.00 | — | 3.00 |
| | ester-based compound 1 | | | | | | |
| | Polyphosphate | — | — | — | — | — | — |
| | ester-based compound 2 | | | | | | |
| | Polyphosphate | — | — | — | — | — | — |
| | ester-based compound 3 | | | | | | |
| | Polyphosphate | — | — | — | — | — | — |
| | ester-based compound 4 | | | | | | |
| | Polyhydric alcohol | — | — | — | — | — | — |
| | Antioxidant | 0.30 | 0.30 | 0.30 | 0.30 | 0.30 | 0.30 |
| | Acid scavenger | 0.30 | 0.30 | 0.30 | 0.30 | 0.30 | 0.30 |
| | Anti-foaming agent | 0.10 | 0.10 | 0.10 | 0.10 | 0.10 | 0.10 |
| (Total) | | 100.00 | 100.00 | 100.00 | 100.00 | 100.00 | 100.00 |
| Test for | Coefficient of friction (—) | 0.085 | 0.066 | 0.059 | 0.055 | 0.053 | 0.052 |
| lubricating | Ring wear amount (mg) | 0.1> | 0.1> | 0.5 | 0.2 | 0.7 | 0.5 |
| properties | | | | | | | |

In each of the Examples and Comparative Examples, the base oil and the additives are as follows.

Numerical values of the respective base oils and additives are mass % on the basis of the whole amount of the refrigerator oil.

### [Base Oil]

PVE: A copolymer of ethyl vinyl ether and isobutyl vinyl ether (molar ratio [(ethyl vinyl ether)/(isobutyl vinyl ester)]=9/1, kinematic viscosity at 100° C.: 7.8 mm²/s), in which both ends thereof are represented by the general formula (A-1-i) and the general formula (A-1-ii), respectively; all of R^{6a} to R^{8a} and R^{11a} to R^{13a} are a hydrogen atom; all of r1 and r2 are 0; and R^{10a} and R^{15a} are each an ethyl group or an isobutyl group.

PAG: Polyoxypropylene glycol (kinematic viscosity at 100° C.: 9.8 mm²/s)

ECP: A copolymer of polypropylene glycol (PPG) and polyethyl vinyl ether (PEV) (molar ratio [PPG/PEV]=5/5, kinematic viscosity at 100° C.: 11.2 mm²/s)

POE: Pentaerythritol octanoate (C8 acid) nonanoate (C9 acid) ester (C8 acid/C9 acid molar ratio: 1/1.1, kinematic viscosity at 100° C.: 8.6 mm²/s)

### [Additives]

Polyphosphate ester-based compound 1: A mixture of compounds represented by the general formula (5) in which n is 1 to 3.

Polyphosphate ester-based compound 2: A mixture of compounds represented by the general formula (5) in which n is 1 to 8.

Polyphosphate ester-based compound 3: A compound represented by the general formula (6).

Polyphosphate ester-based compound 4: A mixture of compounds represented by the general formula (1), in which all of R¹, R³, R⁵, and R⁷ are a hydrogen atom; R², R⁴, R⁶, and R⁸ are each an alkyl group having 1 to 20 carbon atoms; R⁹ is a divalent hydrocarbon group having 2 to 20 carbon atoms; and n is 1 to 8.

Polyhydric alcohol: Dipropylene glycol

Antioxidant: 2,6-Di-tert-butyl-4-methylphenol (DBPC)

Acid scavenger: 2-Ethylhexyl glycidyl ether

Anti-foaming agent: Silicone-based anti-foaming agent

As is clear from the results of the test for lubricating properties of Examples 1 to 13, by incorporating both the polyphosphate ester-based compound and the polyhydric alcohol into the refrigerator oil, the coefficient of friction in the sliding portion of the refrigerator can be reduced. In addition, as is clear from the fact that the ring wear amount is low, the wear resistant became good.

On the other hand, as shown in Comparative Examples 1 to 13, in the case of not incorporating either one or both of the polyphosphate ester-based compound and the polyhydric alcohol into the refrigerator oil, both the wear resistance and the coefficient of friction could not be made good.

1. A refrigerator oil, comprising:
a polyphosphate ester-based compound;
a polyhydric alcohol; and
a base oil containing an oxygen-containing organic compound.

2. The refrigerator oil according to claim 1, wherein a content of the polyphosphate ester-based compound is from 0.01 to 5.0 mass % relative to the whole amount of the refrigerator oil.

3. The refrigerator oil according to claim 1, wherein a content of the polyhydric alcohol is 0.01 mass % or more relative to the whole amount of the refrigerator oil.

4. The refrigerator oil according to claim 1, wherein the oxygen-containing organic compound is at least one selected from the group consisting of a polyvinyl ether compound, a polyoxyalkylene glycol compound, a copolymer of a poly(oxy)alkylene glycol or a monoether thereof and a polyvinyl ether, and a polyol ester compound.

5. The refrigerator oil according to claim 1, wherein the polyphosphate ester-based compound is a compound represented by the following general formula (1): 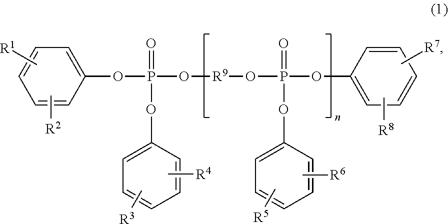
wherein:
n represents an integer of 1 to 10;
R¹ to R⁸ each independently represent a hydrogen atom or an alkyl group having 1 to 20 carbon atoms; and
R⁹ represents a divalent hydrocarbon group having 2 to 20 carbon atoms.

6. The refrigerator oil according to claim 5, wherein R⁹ comprises an arylene group.

7. The refrigerator oil according to claim 5, wherein R⁹ is a divalent hydrocarbon group represented by the following general formula (2) or (3):

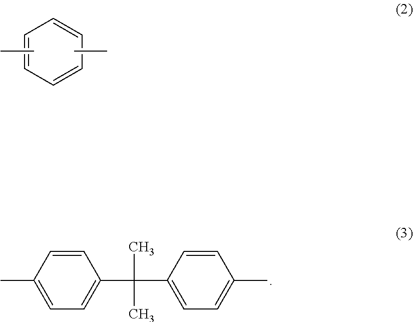

8. The refrigerator oil according to claim 1, wherein the polyphosphate ester-based compound is at least one selected from the group consisting of a compound represented by the following general formula (5) and a compound represented by the following general formula (6): 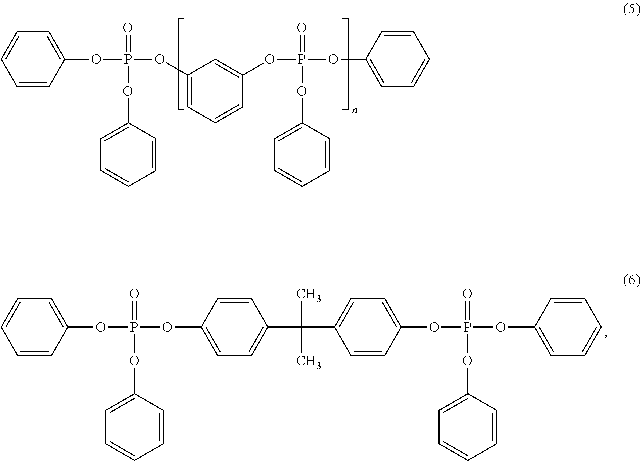
wherein n represents an integer of 1 to 10.

9. The refrigerator oil according to claim 1, wherein the polyhydric alcohol is a (poly)alkylene glycol compound in which the number of carbon atoms of the alkylene group is 2 to 4, and the number of oxyalkylene units in one molecule thereof is 1 to 4.

10. The refrigerator oil according to claim 1, wherein the polyhydric alcohol is dipropylene glycol.

11. The refrigerator oil according to claim 1, which does not substantially contain a metal salt of an organic carboxylic acid having 6 to 60 carbon atoms.

12. The refrigerator oil according to claim 1, which does not substantially contain potassium oleate.

13. A refrigerator oil composition, comprising a refrigerant and the refrigerator oil according to claim 1.

14. The refrigerator oil composition according to claim 13, wherein the refrigerant comprises at least one selected from the group consisting of a fluorinated hydrocarbon, carbon dioxide, a hydrocarbon, and ammonia.

15. A method for producing a refrigerator oil, the method comprising blending a base oil containing an oxygen-containing organic compound with at least a polyphosphate ester-based compound and a polyhydric alcohol, to obtain a refrigerator oil.
